(19) United States
(12) Patent Application Publication
(10) Pub. No.: US 2013/0139571 A1
(43) Pub. Date: Jun. 6, 2013

(54) DIFFERENTIAL PRESSURE MEASURING DEVICE AND DEGREE OF POLLUTION MONITORING UNIT AND FILTER UNIT

(71) Applicant: Alfred Gröner, Ohringen (DE)

(72) Inventor: Alfred Gröner, Ohringen (DE)

(73) Assignee: MAHLE INTERNATIONAL GMBH, Stuttgart (DE)

(21) Appl. No.: 13/698,994

(22) PCT Filed: May 17, 2011
(86) PCT No.: PCT/EP11/57973

§ 371 Date: Feb. 4, 2013

(30) Foreign Application Priority Data
May 20, 2010 (DE) 102010022119.8

(51) Int. Cl. G01N 15/08; G01L 7/16

(52) U.S. Cl. CPC G01N 15/0826; G01L 7/163
USPC 73/38; 73/744

(57) ABSTRACT

A differential pressure measurement device may include a piston arranged in a cylinder and configured to define a first pressure space from a second pressure space within the cylinder. A first piston rod may be fixed to the piston and guided through the first pressure space out of the cylinder. A pressure sensor may be configured to interact with the first piston rod to measure a compressive force with which the first piston rod presses against the pressure sensor. A second piston rod may be fixed to the piston and guided through the second pressure space out of the cylinder. The chamber may be connected to a surface section of the pressure sensor which interacts with the first piston rod.

### CROSS-REFERENCE TO RELATED APPLICATIONS

This application claims priority to German Patent Application 10 2010 022 119.8, filed on May 20, 2010, and International Patent Application PCT/EP2011/057973, filed on May 17, 2011, both of which are hereby incorporated by reference in their entirety.

### TECHNICAL FIELD

The present invention relates to a differential pressure measurement device, in particular for a contamination monitoring unit of a filter unit. The invention also relates to a contamination monitoring unit for a filter unit which is equipped with such a differential pressure measurement device. The present invention also relates to a filter unit, in particular for filtering liquids, which is equipped with such a contamination monitoring unit and differential pressure measurement device.

### BACKGROUND

A filter unit, with the aid of which dirt is filtered out of a fluid, usually comprises a filter element which separates an inlet side from a clean side. During filter use, the filtered out dirt can accumulate on the inlet side of the filter element, which results in contamination of the filter element. With increasing contamination, the flow resistance of the filter element and thus the pressure load of the filter element also increases. In order to reduce the risk of damage to the filter element and the risk of an excessively small fluid flow in a system equipped with the filter unit, it is expedient to monitor the degree of contamination of the filter element. If the contamination exceeds a certain degree of contamination, the filter element must be cleaned or replaced.

As the degree of contamination of the filter element correlates with the flow resistance, the pressure difference between the inlet side and the clean side can be used to monitor the degree of contamination. To do this, it is in principle possible to arrange one pressure sensor on the inlet side and one on the clean side, which measures the absolute pressures on the inlet side and on the clean side. The differential pressure prevailing between the inlet side and the clean side can then be determined by means of a corresponding evaluation unit. Problems arise with such a procedure that the filter unit or the system equipped therewith operates at a relatively high pressure level and the tolerable pressure difference is comparatively low compared to this working pressure level. Pressure sensors have a measurement tolerance which can usually be ±1%. At a high pressure level, which can be for example 200 bar, the measured pressures then have an inaccuracy of ±2 bar. If such an absolute pressure sensor is used for differential pressure measurement on both the inlet side and clean side, the tolerances can add up, so the measured differential pressure can have deviations of ±4 bar. If only a small differential pressure of for example 20 bar is tolerable compared to the pressure level, measurement errors of ±20% must be expected in this procedure. In order to be able to rule out failure of the filter unit in the event of such measurement inaccuracies, the tolerable differential pressure must be reduced correspondingly, which ultimately results in premature maintenance intervals and unnecessary downtimes of the system.

### SUMMARY

The present invention is concerned with the problem of specifying an improved embodiment for a filter unit or for an associated contamination monitoring unit or for a differential pressure measurement device, which is characterised in particular by increased measurement accuracy.

This problem is solved according to the invention by the subject matter of the independent claims. Advantageous embodiments form the subject matter of the dependent claims.

The invention is based on the general concept of applying only the differential pressure to a pressure sensor, so that the pressure sensor can measure the comparatively small pressure difference directly, independently of the respective pressure level. This makes it possible in particular to use a pressure sensor which is matched to the tolerable differential pressure. With reference to the above-mentioned numerical example, the pressure sensor can be designed for a pressure range up to 20 bar, its measurement accuracy again being 1%, so measurement errors of ±0.2 bar can occur. As only one sensor is necessary, there is no doubling of the measurement tolerances. The pressure difference can be determined with comparatively high accuracy. Compared to the example described in the introduction, the advantage of improved measurement accuracy is clear. The smaller the tolerable pressure difference between the inlet side and the clean side, greater the effect of the advantage of the invention presented here. With different hydraulic systems, the working pressure can be for example approximately 200 bar, while the tolerable differential pressure at the filter element is approximately 5 bar. When two absolute pressure sensors are used, which can each measure up to 200 bar, just the measurement accuracy is of the same order of magnitude as the differential pressure values to be measured. When a differential pressure sensor is used according to the invention, it can be designed for the 5 bar to be measured, so that its measurement tolerance is 0.05 bar.

According to the invention, the use of a single pressure sensor thereby allows the differential pressure measurement device to be equipped with a piston, which is arranged in a vertically movable manner in a cylinder and separates a first pressure space from a second pressure space within the said cylinder. The piston actuates the pressure sensor by means of a piston rod. The piston and the cylinder are matched to each other in such a manner that the piston can transmit only the pressure difference prevailing between the two pressure spaces to the pressure sensor via the pressure rod. Because of this construction, the high absolute pressures cancel each other out except for the pressure difference to be measured, so that only the pressure difference to be measured acts as a resulting force on the piston and exerts a corresponding displacement force on the piston, which the piston transmits to the pressure sensor via the piston rod.

According to an advantageous embodiment, the piston has a first piston face, which is exposed to the first pressure space, and a second piston face, which is exposed to the second pressure space. The first piston face and the second piston face are of equal size within the framework of manufacturing tolerances. This means that the high pressures in the two opposite pressure spaces are largely equalised at the piston owing to the selected geometry, so ultimately only the pressure difference acts on the piston as the resulting force.

According to a particularly advantageous embodiment, the piston can have a second piston rod, which is guided through the second pressure space out of the cylinder, in addition to the first piston rod which interacts with the pressure sensor. This measure makes it easier to make the two hydraulically active piston faces acting in opposite directions the same size. The two piston faces are then formed by annular faces, which extend coaxially to the respective piston rod. The two piston rods expediently have the same cross sections, which likewise makes it easier to make the two hydraulically active piston faces the same size.

According to another advantageous embodiment, the second piston rod can penetrate a chamber outside the cylinder, which chamber is fluidically connected to a surface section of the pressure sensor with which the first piston rod interacts. This largely achieves a pressure equalisation and thus a force equalisation between the end faces of the two piston rods, so that ultimately only the pressure difference between the two pressure spaces which acts on the piston drives the piston against the pressure sensor.

In this case an embodiment is expedient in which the chamber interacting with the second piston rod is connected fluidically to the surface section of the pressure sensor through the two piston rods and through the piston. This measure allows the fluidic coupling between the pressure sensor and the chamber to be realised particularly easily.

According to another advantageous embodiment, the first piston rod can bear against the pressure sensor in a forceless or pressureless manner in a starting state in which the same pressure prevails in both pressure spaces. Loose contact between the piston rod and the pressure sensor is consequently preferred. In principle, the piston rod can also be connected fixedly to the pressure sensor.

Further important features and advantages of the invention can be found in the subclaims, the drawing and the associated description of the figures using the drawing.

It is self-evident that the features which are mentioned above and those which are still to be explained below can be used not only in the combination specified in each case, but also in other combinations or alone without departing from the scope of the present invention.

Preferred exemplary embodiments of the invention are shown in the drawing and explained in more detail in the description below.

### BRIEF DESCRIPTION OF THE DRAWINGS

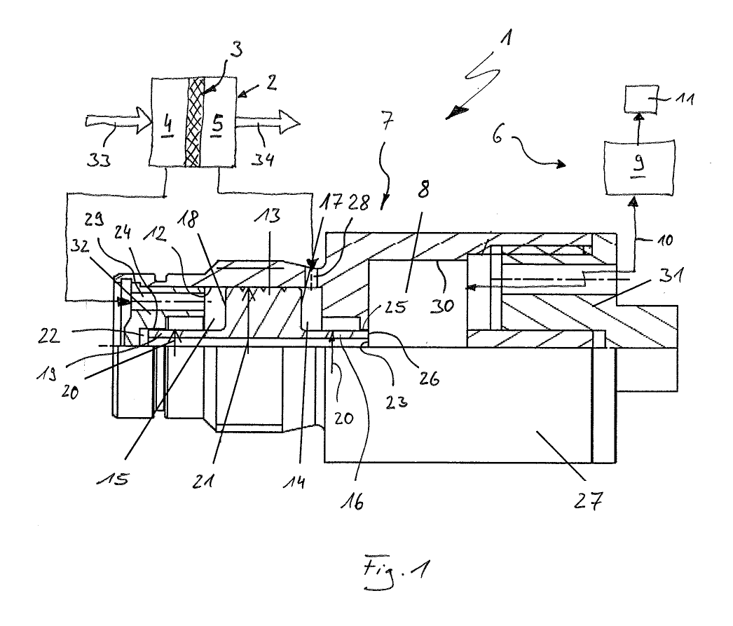

The single FIG. 1 shows a circuit-diagram-like principle diagram of a filter unit having a contamination monitoring unit, which operates with a differential pressure measurement unit which is shown in half section.

### DETAILED DESCRIPTION

According to FIG. 1, a filter unit 1 comprises a filter housing 2, in which a filter element 3 separates an inlet side 4 from a clean side 5. In principle, the filter unit 1 can be used to filter out liquid or solid dirt from a gaseous or liquid fluid. The filter unit 1 is preferably used to filter liquids and can be used in hydraulic systems. For example, the filter unit 1 can be used to clean the cooling lubricant in a cooling lubricant system.

The filter unit 1 is equipped with a contamination monitoring unit 6 which has a differential pressure measurement device 7. The contamination monitoring unit 6 is used to monitor the degree of contamination of the filter element 3 of the filter unit 1. As the degree of contamination of the filter element 3 correlates with a flow resistance of the filter element 3, and as this flow resistance correlates with a pressure difference arising between the inlet side 4 and clean side 5 during use of the filter unit 1, the contamination monitoring unit 6 works with the differential pressure measurement device 7. The latter has exactly one pressure sensor 8. It manages in principle with only one pressure sensor 8. However, two or more pressure sensors 8 can also be provided for redundancy. The contamination monitoring unit 6 is also equipped with an evaluation unit 9, which is coupled to the pressure sensor 8 in a suitable manner, for example via a signal line 10. The evaluation unit 9 is furthermore coupled to a display unit 11, which signals the differential pressure measured with the aid of the pressure sensor 8 and/or the degree of contamination correlated therewith. The evaluation unit 9 can determine a degree of contamination for the filter element 3 as a function of the differential pressure which it receives from the pressure sensor 8. If the determined degree of contamination exceeds a predefined limit value, a corresponding warning signal can be output via the display unit 11.

The differential pressure measurement device 7 has a cylinder 12 and a piston 13, which is arranged in a vertically movable manner in the cylinder 12. The piston 13 also separates a first pressure space 14 from a second pressure space 15 in the cylinder 12. Connected fixedly to the piston 13 is a first piston rod 16, which is guided through the first pressure space 14 and out of the cylinder 12. The first piston rod 16 interacts with the pressure sensor 8 outside the cylinder 12, so that the pressure sensor 8 can measure the compressive force with which the first piston rod 16 presses against the pressure sensor 8.

The piston 13 has a first piston face 17 and a second piston face 18, which are selected to be of equal size. The first piston face 17 faces or is exposed to the first pressure space 14, while the second piston face 18 faces or is exposed to the second pressure space 15. Correspondingly, compressive forces which are oriented in opposite directions at the two piston faces 17, 18 act on the piston 13, as a result of which only a resulting force which represents the pressure difference between the two pressure spaces 14, 15 acts on the piston 13, which force drives the piston 13 and thus the first piston rod 16 against the pressure sensor 8.

So that the two piston faces 17, 18 can be made the same size in a particularly simple manner, the piston 13 is expediently connected fixedly to a second piston rod 19, which is guided through the second pressure space 15 out of the cylinder 12. The two piston rods 16, 19 are thus formed on two mutually opposite ends of the piston 13. The two piston rods 16, 19 expediently have the same cross sections 20. The two piston rods 16, 19 are arranged coaxially to the piston 13, so that the two piston faces 17, 18 enclose the respective piston rod 16, 19 in an annular manner and are formed by annular faces. The size of the piston faces 17, 18 is produced by the cross section 21 of the cylinder 12 minus the cross section 20 of the respective piston rod 16, 19. The respective piston rod 16, 19 is preferably integrally formed on the piston 13.

In the embodiment shown here, the second piston rod 19 penetrates a chamber 22 outside the cylinder 12. This chamber 22 is connected fluidically to a surface section 23 of the pressure sensor 8. The surface section 23 is the surface section 23 which interacts with the first piston rod 16 for the purpose of pressure measurement. Owing to the fluidic coupling of the chamber 22 to the surface section 23, the same pressure prevails in the region of the axial ends of the two piston rods 16, 19, so only the pressure difference acting on the piston faces 17, 18 drives the piston 13. To couple the chamber 22 fluidically to the surface section 23 of the pressure sensor 8, the two piston rods 16, 19 are formed as hollow rods and the piston 13 is formed as a hollow piston. Correspondingly, the chamber 22 can communicate fluidically with the surface section 23 of the pressure sensor 8 through the two piston rods 16, 19 and through the piston 13.

A seal 24 which interacts with the second piston rod 19 can be provided between the chamber 22 and the second pressure space 15. This seal 24 can in particular be designed as a flat seal which operates with a throttle sealing gap. Such a flat seal can for example be produced by two mating surfaces which interact with each other. In addition, at least one seal 25 can expediently be provided between the pressure sensor 8 and the first pressure space 14, which seal interacts with the first piston rod 16. This seal 25 can expediently also be formed as a flat seal, which is realised by mating surfaces and operates with a throttle sealing gap. The pressure level, which may be high, of the two pressure spaces 14, 15 can reach the chamber 22 and the surface section 23 only to a greatly restricted extent or not at all owing to the two seals 24, 25. Consequently, a pressure difference arising between the first piston rod 16 and the pressure sensor 8 owing to the annular bearing 26 can only assume a small value, which is substantially insignificant for the measurement of the pressure difference between the two pressure spaces 14, 15.

The first piston rod 16 can come to bear on the pressure sensor 8 in a starting state, which is present when the same pressure prevails in the two pressure spaces 14, 15, for example when the filter unit 1 is shut off. This bearing can be loose and forceless or pressureless.

To realise the differential pressure measurement device 7, it can also be equipped with a housing 27, the housing 27 having the cylinder 12, a first pressure connection 28 which is fluidically connected to the first pressure space 14 and a second pressure connection 29 which is fluidically connected to the second pressure space 15. The housing 27 also contains a receiving space 30 for receiving the pressure sensor 8. This receiving space 30 can be closed with a screw closure 31, as a result of which positional fixing and pretensioning of the pressure sensor 8 in the housing 27 can be realised at the same time. The electrical contact between the pressure sensor 8 and the evaluation unit 9 can take place though the closure 31. The chamber 22 is also formed in the housing 27, in a cover 32 which is inserted into the cylinder 12. The second pressure connection 29 is also formed in the cover 32 in the example shown here.

The first pressure connection 28 is attached to the clean side 5 of the filter housing 2, so that the first pressure space 14 receives the clean-side pressure when the filter unit 1 is in use. The second pressure connection 29 is attached to the inlet side 4 of the filter housing 2, so that the second pressure space 15 receives the inlet-side pressure when the filter unit 1 is in use.

The differential pressure measurement device 7 shown here operates as follows:

When the filter unit 1 is in use, an inlet-side, dirty feed flow 33 is supplied to the inlet side 4. When flow passes through the filter element 3, there is a fall in pressure, so a clean-side outlet flow 34 which is largely free of dirt flows out of the clean side 5. The pressure level at which the feed flow 33 and the outlet flow 34 are is comparatively high and can be for example approximately 200 bar. The higher inlet-side pressure also prevails in the second pressure space 15, while the lower clean-side pressure also prevails in the first pressure space 14. As the two piston faces 17, 18 are of equal size, a resulting force is ultimately produced at the piston 13, which force only corresponds to the pressure difference between the inlet side 4 and the clean side 5. This resulting force drives the piston 13 in the direction of the pressure sensor 8. The piston 13 is supported on the pressure sensor 8 by means of the first piston rod 16, so the resulting compressive force of the piston 13 is introduced into the pressure sensor 8 via the first piston rod 16. For example, the pressure difference between the inlet side 4 and the clean side 5 should be no more than 20 bar or 5 bar to prevent undersupply of the respective system or damage to the filter element 3. Correspondingly, the pressure sensor 8 must be designed to measure absolute pressures up to 20 bar or 5 bar, respectively. With a usual measurement accuracy of pressure sensors 8, which is approximately 1% of the pressure range for which the pressure sensor 8 is designed, this results in measurement errors in the region of ±0.2 bar with a design for 20 bar and measurement errors in the region of ±0.05 bar with a design for 5 bar.

The differential pressure measurement device 7 shown here thus operates very precisely, although the pressure difference between two pressures which are themselves at a comparatively high pressure level must be measured.
The evaluation unit 9 determines the measured pressure difference and a degree of contamination for the filter element 3 correlated therewith from the measurement signals of the pressure sensor 8. As soon as an impermissibly high differential pressure or an impermissibly high degree of contamination is determined, a corresponding warning signal can be output via the signal unit 11. In principle, an emergency shutdown of the system is likewise conceivable. However, cascading measures are preferable, which trigger different measures at successive limit values for the pressure difference or for the degree of contamination.

1. A differential pressure measurement device, comprising:
a piston arranged in a vertically movable manner in a cylinder configured to define a first pressure space from a second pressure space in the cylinder,
a first piston rod fixed to the piston and guided through the first pressure space out of the cylinder,
a pressure sensor configured to interact outside the cylinder with the first piston rod to measure a compressive force with which the first piston rod presses against the pressure sensor.
a second piston rod fixed to the piston, wherein
the second piston rod is guided through the second pressure space out of the cylinder and penetrates a chamber outside the cylinder, the chamber being fluidically connected to a surface section of the pressure sensor which interacts with the first piston rod.

2. The differential pressure measurement device according to claim 1, wherein
the piston has a first piston face exposed to the first pressure space and a second piston face exposed to the second pressure space, and further wherein the first piston face and the second piston face are of equal size.

3. The differential pressure measurement device according to claim 1, wherein the two piston rods have the same cross sections.

4. The differential pressure measurement device according to claim 1, wherein the piston faces enclose the respective piston rod in an annular manner.

5. The differential pressure measurement device according to claim 1, wherein the chamber is connected fluidically to the surface section through the piston rods and through the piston.

6. The differential pressure measurement device according to claim 1, wherein at least one seal interacting with the second piston rod is arranged between the chamber and the second pressure space, and further wherein the seal is formed as a flat seal.

7. The differential pressure measurement device according to claim 1, wherein at least one seal interacting with the first piston rod is arranged between the pressure sensor and the first pressure space, and further wherein the seal is formed as a flat seal.

8. The differential pressure measurement device according to claim 1, wherein the first piston rod bears against the pressure sensor in a starting state, and further wherein in the starting state the pressure in each of the two pressure spaces is equal.

9. The differential pressure measurement device according to claim 1, further comprising
a housing containing the cylinder and having a first pressure connection connected fluidically to the first pressure space and a second pressure connection connected to the second pressure space.

10. The differential pressure measurement device according to claim 9, wherein
the pressure sensor is arranged in the housing.

11. A contamination monitoring unit for a filter unit, comprising:
a filter unit having a filter element configured to separate an inlet side from a clean side in a filter housing of the filter unit,
a piston arranged in a vertically movable manner in a cylinder configured to define a first pressure space from a second pressure space in the cylinder, the piston having
a differential pressure measurement device,
wherein the first pressure space is fluidically connected to the clean side,
wherein the second pressure space is fluidically connected to the inlet side, and
wherein an evaluation unit is coupled to the pressure sensor and determined a degree of contamination of the filter element as a function of the differential pressure.

12. A filter unit for filtering liquids, comprising:
a filter element, which separates an inlet side from a clean side in a filter,
a piston arranged in a vertically movable manner in a cylinder configured to define a first pressure space from a second pressure space in the cylinder, the piston
having a differential pressure measurement device,
wherein the first pressure space is fluidically connected to the clean side, and
wherein the second pressure space is fluidically connected to the inlet side.

13. The differential pressure measurement device according to claim 9, wherein the chamber is arranged in a cover of the housing.

14. The differential pressure measurement device according to claim 2, wherein the two piston rods have the same cross sections.

15. The differential pressure measurement device according to claim 14, wherein the piston faces enclose the respective piston rod in an annular manner.

16. The differential pressure measurement device according to claim 15, wherein the chamber is connected fluidically to the surface section through the piston rods and through the piston.

17. The differential pressure measurement device according to claim 16, wherein at least one seal interacting with the second piston rod is arranged between the chamber and the second pressure space, and further wherein the seal is formed as a flat seal.

18. The differential pressure measurement device according to claim 17, wherein at least one seal interacting with the first piston rod is arranged between the pressure sensor and the first pressure space, and further wherein the seal is formed as a flat seal.

19. The differential pressure measurement device according to claim 18, wherein the first piston rod bears against the pressure sensor in a starting state, and further wherein in the starting state the pressure in each of the two pressure spaces is equal.

20. The differential pressure measurement device according to claim 19, further comprising a housing containing the cylinder and having a first pressure connection connected fluidically to the first pressure space and a second pressure connection connected to the second pressure space.
